(19) United States
(12) Patent Application Publication
(10) Pub. No.: US 2025/0368282 A1
(43) Pub. Date: Dec. 4, 2025

(54) SEGMENTED WHEEL SYSTEM AND COMPONENTS THEREOF

(71) Applicant: Ironwood Designs, LLC, Beaverton, OR (US)

(72) Inventor: Richard D. CARTWRIGHT, Beaverton, OR (US)

(73) Assignee: Ironwood Designs, LLC, Beaverton, OR (US)

(21) Appl. No.: 19/224,774

(22) Filed: May 31, 2025

Related U.S. Application Data
(63) Continuation-in-part of application No. 29/955,037, filed on Jul. 30, 2024, now Pat. No. D1078594.
(60) Provisional application No. 63/654,668, filed on May 31, 2024.

(51) Int. Cl. B62D 55/26; B62D 55/12

(52) U.S. Cl. CPC B62D 55/26; B62D 55/12

(57) ABSTRACT

A segmented wheel system for a track vehicle including: (a) the track vehicle having a plurality of segmented wheels; (b) a track belt surrounding at least two of the segmented wheels, the track belt having an inner surface and an outer surface, the inner surface nearer to the segmented wheel than the outer surface; (c) at least one wheel guide positioned on the inner surface of the track belt; and at least one grouser positioned on the outer surface of the track belt.

The present application is an application claiming the benefit of U.S. Provisional Patent Application No. 63/654,668, filed May 31, 2024, and a continuation-in-part of U.S. Design Patent Application Number 29/955,037, filed Jul. 30, 2024. The present application is based on and claims priority from these applications, the disclosures of which are hereby expressly incorporated herein by reference in their entirety. Should any irreconcilable conflicts arise between this patent application and the just-mentioned earlier patent applications for purposes of claim construction or interpretation, then this patent application's teachings shall govern.

### TECHNICAL FIELD

The present disclosure describes apparatuses, methods, and/or systems that generally relate to the technical field of a segmented wheel system and components thereof, and specifically relate to the technical field of a segmented wheel system that includes at least one segmented wheel, at least one wheel guide, and/or at least one grouser.

### BACKGROUND

The present application describes improvements to the inventions described in U.S. Pat. No. 5,330,019 to Cartwright, U.S. Pat. No. 6,540,310 to Cartwright, U.S. Design Patent No. D298,018 to Cartwright, U.S. Design Patent No. D473,244 to Cartwright, U.S. Design Patent No. D478,025 to Cartwright, and/or U.S. Design Patent No. D478,026 to Cartwright. All of these references were invented by the inventor of the present invention and are referred to jointly as the “Cartwright references.” The Cartwright references are incorporated herein by reference in their entirety.

A track vehicle includes an elongate continuous crawler track (also referred to as a “track belt,” “continuous track belt,” or “track”) trained over a plurality of tires, with the track belt in powered movement serving to propel the vehicle over the ground. At least one surface of the track belt is covered with elongate “teeth” extending from the front edge to the back edge. The track belt is currently made of rubber. Track vehicles are any vehicle having a track belt trained over a plurality of tires with the track belt in powered movement serving to propel the vehicle over the ground. Track vehicles may further include any vehicle having a track belt trained over a single tire.

So-called “all-terrain vehicles” (ATVs) are used by many types of riders (e.g., hunters, recreationalists, forestry personnel, military personnel, firefighting and rescue personnel, law enforcement, ski area personnel, linemen and other utility personnel, farmers, etc.) to provide transport over different types of terrain (e.g., paved roads, snow, ice, sand, gravel, mud, rough roads, nonexistent roads, etc.). Many all-terrain vehicles are relatively compact, and include a pair of power-driven rear wheels suitably mounted at the rear end of a motorcycle-type frame, where the operator sits on a seat with legs straddling a compartment where a motor and controls for powering the vehicle are located. Exemplary all-terrain vehicles include, but are not limited to, the Kawasaki Brute Force(R) 750 (Kawasaki 750 “Brute Force”) and the Honda Pioneer 1000 (Honda 1000 CC “Pioneer”).

“Utility terrain vehicles” (UTVs) are versatile off-road vehicles ideal for both heavy-duty tasks and recreational activities. Utility terrain vehicles are typically larger, more powerful (e.g., have a greater towing capacity and greater speed), have greater seating and storage capacity, and have more safety features than all-terrain vehicles. They are commonly used to haul people, equipment, and/or supplies in locations that make using a truck impractical or impossible. Exemplary all-terrain vehicles include, but are not limited to, the Honda Pioneer 1000 (1000 CC Honda “Pioneer”), the Can-Am Defender (Can-Am “Defender” 1000 CC), the Yamaha Wolverine RMAX 2 1000 (Yamaha “Wolverine RMAX2” 1000 CC), and the Tuatara 1000 EFI (Tuatara “EFI” 1000 CC).

U.S. Pat. No. 5,330,019 describes a vehicle that has significantly greater pulling power than a conventional all-terrain vehicle. The vehicle is supported by a track belt system with enhanced ability to travel over the ground and float rather than sink into the terrain. This patent also discloses the use of grouser structures on the outer surfaces of track belts to provide traction, enhanced gripping action with softer terrain, good road ability and steer ability with harder terrain surfaces, long life and low maintenance, and ease of repair and replacement of a grouser structure if needed. The disclosed grouser has a plastic grouser body and a spline element (also referred to as a track bar or anchor plate) that may be secured by fasteners to a track belt to hold it in place.

U.S. Pat. No. 6,540,310 describes a grouser structure for use on an outer surface of a continuous track belt to provide traction and shock absorption, the grouser structure including a grouser body that defines a grouser chamber and a spline element positioned within the grouser chamber. In one preferred embodiment, a shock absorption gap is formed between the inner chamber peripheral surface and the outer spline peripheral surface. In another preferred embodiment, the base of the grouser body is solid or contains other structure to prevent the first body side leg and the second body side leg from spreading. In yet another preferred embodiment, the spline element is a solid reinforcement spline element. In still another preferred embodiment, the spline element is associated with an extension section to which an ice cleat may be functionally attached. This patent also describes the use of “tire guides.” U.S. Design Patent No. D473,244 shows an exemplary grouser.

U.S. Pat. No. 11,331,949 to Scheer et al. is directed to a tire having replaceable discrete traction elements. A tire may comprise a hub and a plurality of discrete traction elements coupled to the hub. Each of the traction elements may comprise a backing plate and an elastomeric material bonded to the backing plate. Circumferentially adjacent traction elements may axially overlap.

U.S. Pat. No. 11,148,468 to Ballena is directed to a non-pneumatic tire with individual tire modules. The non-pneumatic tire has a plurality of individual modules and is mounted on a wheel having with a plurality of depressed module mounting slots to form a wheel and tire assembly. Each module has a body with an opening in the middle that separates the upper region from the lower region. The lower region has an attachment hole for attaching the module to the mounting slot. The lower region of the module and the mounting slot are shaped accordingly to fit each other.

The module has two arms, each having an interlocking face disposed at their ends. A full set of interconnected modules forms a complete annular tire. The wheel includes a plurality of depressed mounting slots with a wheel attachment hole disposed around the rim where the modules can be mounted. The rim includes flanges that bound the mounting slot on both sides preventing the modules from sliding sideways.

### SUMMARY

Described herein is a segmented wheel system for a track vehicle, the system including: (a) the track vehicle having a plurality of segmented wheels; (b) a track belt surrounding at least one segmented wheel, the track belt having an inner surface and an outer surface, the inner surface nearer to the at least one segmented wheel than the outer surface; (c) at least one wheel guide positioned on the inner surface of the track belt; and at least one grouser positioned on the outer surface of the track belt.

Each of the plurality of segmented wheels may have a central disk and a plurality of wheel segments.

The at least one segmented wheel may be a plurality of segmented wheels. If there is a plurality of segmented wheels, the track belt surrounds the plurality of segmented wheels such that the inner surface is nearer to the plurality of segmented wheels than the outer surface.

Each of the plurality of segmented wheels may have the following: (a) a central disk having an outer peripheral edge, a central aperture, and a plurality of evenly spaced disk connection apertures positioned slightly inward from the peripheral edge; (b) a plurality of wheel segments, each wheel segment having an inner diameter surface, an outer diameter surface, two faces, and two ends; (c) the inner diameter surface having an interconnection slot defined therein; and (d) for each wheel segment, the outer peripheral edge of the central disk is positioned within the interconnection slot of the wheel segment, the wheel segment is positioned such that the segment connection aperture aligns with one of the disk connection apertures, and a bolt is positioned within a channel formed by the segment connection aperture and the disk connection aperture.

Each wheel guide may have a longitudinal length that includes a first end section, a first upwardly extending guide ear, a radiused valley, a second upwardly extending guide ear, and a second end section.

Each wheel guide may include the following: (a) a longitudinal length that includes a first end section, a first upwardly extending guide ear, a radiused valley, a second upwardly extending guide ear, and a second end section; (b) the radiused valley having a radiused central section flanked on both ends by the guide ears; (c) the radiused valley having a central elongate tooth parallel to the longitudinal length; and (d) the radiused valley on either side of the central elongate tooth angled downward from the central elongate tooth.

A segmented wheel preferably includes: (a) a central disk having an outer peripheral edge, a central aperture, and a plurality of evenly spaced disk connection apertures positioned slightly inward from the peripheral edge; (b) a plurality of wheel segments, each wheel segment having an inner diameter surface, an outer diameter surface, two faces, and two ends; (c) the inner diameter surface having an interconnection slot defined therein; and (d) for each wheel segment, the outer peripheral edge of the central disk is positioned within the interconnection slot of the wheel segment, the wheel segment is positioned such that the segment connection aperture aligns with one of the disk connection apertures, and a bolt is positioned within a channel formed by the segment connection aperture and the disk connection aperture.

Objectives, features, combinations, and advantages described and implied herein will be more readily understood upon consideration of the following detailed description of the invention, taken in conjunction with the accompanying drawings. The subject matter described herein is also particularly pointed out and distinctly claimed in the concluding portion of this specification.

### DESCRIPTION OF THE DRAWINGS

The accompanying drawings illustrate various exemplary segmented wheel systems, components of various exemplary segmented wheel systems, and/or provide teachings by which the various exemplary segmented wheel systems are more readily understood.

FIG. 1 is an isometric view of an exemplary track vehicle with front segmented wheels (shown as a segmented wheel on each side of the track vehicle) surrounded by a track belt, and rear segmented wheels (shown as a plurality of segmented wheels on each side of the track vehicle) that are spanned and surrounded by a track belt.

FIG. 2 is a front view of an exemplary front segmented wheel (a central disk surrounded by a plurality of wheel segments) surrounded by a track belt, the track belt having wheel guides on its interior annular surface and grousers on its outer annular surface.

FIG. 3 is an enlarged front view of a portion of an exemplary front segmented wheel (surrounded by the track belt, wheel guides, and grousers) traversing uneven ground.

FIG. 4 is an isometric view of a portion of an exemplary front track belt showing grousers (each with a threaded spine therein) and spacers in an exemplary pattern.

FIG. 5 is a front view of an exemplary rear segmented wheel (a central disk surrounded by a plurality of wheel segments) partially surrounded by a track belt (the track belt surrounding a plurality of segmented wheels as shown in FIG. 1), the track belt having wheel guides on its interior annular surface and grousers on its outer annular surface.

FIG. 6 is an enlarged front view of a portion of an exemplary rear segmented wheel (partially surrounded by the track belt, wheel guides, and grousers) traversing uneven ground.

FIG. 7 is an isometric view of a portion of an exemplary track belt showing grousers (each with a threaded spine therein, some of the threaded spines having at least one ice cleat) and spacers in an exemplary pattern.

FIG. 8 is an isometric view of an exemplary rear segmented wheel (a central disk surrounded by a plurality of wheel segments) partially surrounded by a track belt (the track belt surrounding a plurality of segmented wheels as shown in FIG. 1), the track belt having wheel guides on its interior annular surface and grousers on its outer annular surface.

FIG. 9 is a cross-sectional view of a portion an exemplary rear segmented wheel, a portion of a central disk, a portion of track belt, a wheel guide, and spaced side grousers.

FIG. 10 is a cross-sectional view of an exemplary rear segmented wheel (a central disk surrounded by a plurality of wheel segments), track belt, a wheel guide, and a centrally positioned grouser.

FIG. 11 is an isometric view of an exemplary central disk.

FIG. 12 is an isometric view of an exemplary segmented wheel including wheel segments surrounding an exemplary central disk.

FIG. 13 is a front view of the segmented wheel of FIG. 12.

FIG. 14 is a rear view of the segmented wheel of FIG. 12.

FIG. 15 is a side view of the segmented wheel of FIG. 12, the opposite view, top view, and bottom view being identical.

FIG. 16 is an isometric view of an exemplary segmented wheel including wheel segments surrounding an exemplary central disk, all but one wheel segment being shown in dashed lines.

FIG. 17 is a top-front isometric view of an exemplary wheel segment of a segmented wheel.

FIG. 18 is a bottom-rear isometric view of the wheel segment of FIG. 17.

FIG. 19 is a front view of the wheel segment of FIG. 17.

FIG. 20 is a rear view of the wheel segment of FIG. 17.

FIG. 21 is a top view of the wheel segment of FIG. 17.

FIG. 22 is a bottom view of the wheel segment of FIG. 17.

FIG. 23 is a first side view of the wheel segment of FIG. 17.

FIG. 24 is a second side view of the wheel segment of FIG. 17.

FIG. 25 is a top-front isometric view of an exemplary wheel segment of a segmented wheel (the length, width, and height being of indeterminate length) and, in particular, the top surface and teeth thereof.

FIG. 26 is a bottom-rear isometric view of the wheel segment of FIG. 25.

FIG. 27 is a front view of the wheel segment of FIG. 25.

FIG. 28 is a rear view of the wheel segment of FIG. 25.

FIG. 29 is a top view of the wheel segment of FIG. 25.

FIG. 30 is a bottom view of the wheel segment of FIG. 25.

FIG. 31 is a first side view of the wheel segment of FIG. 25.

FIG. 32 is a second side view of the wheel segment of FIG. 25.

FIG. 33 is a first isometric view of an exemplary wheel guide including a first end section, a first upwardly extending guide ear, a “radiused valley,” a second upwardly extending guide ear, and a second end section.

FIG. 34 is a second isometric view of the exemplary wheel guide of FIG. 33.

FIG. 35 is a first side view of the exemplary wheel guide of FIG. 33, the second side view being a mirror image thereof.

FIG. 36 is a top view of the exemplary wheel guide of FIG. 33.

FIG. 37 is a front view of the exemplary wheel guide of FIG. 33, the rear view being a mirror image thereof.

FIG. 38 is a bottom view of the exemplary wheel guide of FIG. 33.

FIG. 39 is a first isometric view of an exemplary wheel plate including a first end section, a first flat plate section, a “radiused valley,” a second flat plate section, and a second end section.

FIG. 40 is a second isometric view of the exemplary wheel plate of FIG. 39.

FIG. 41 is a first side view of the exemplary wheel plate of FIG. 39, the second side view being a mirror image thereof.

FIG. 42 is a top view of the exemplary wheel plate of FIG. 39.

FIG. 43 is a front view of the exemplary wheel plate of FIG. 39, the rear view being a mirror image thereof.

FIG. 44 is a bottom view of the exemplary wheel plate of FIG. 39.

FIG. 45 is a first isometric view of an exemplary grouser.

FIG. 46 is a second isometric view of the exemplary grouser of FIG. 45.

FIG. 47 is a first side view of the exemplary grouser of FIG. 45.

FIG. 48 is a second side view of the exemplary grouser of FIG. 45, this view showing a reinforcement foot.

FIG. 49 is a top view of the exemplary grouser of FIG. 45.

FIG. 50 is a front view of the exemplary grouser of FIG. 45, the rear view being a mirror image thereof.

FIG. 51 is a bottom view of the exemplary grouser of FIG. 45.

FIG. 52 is an isometric view of an exemplary elongate spine having at least one removable and replaceable ice cleat.

FIG. 53 is an isometric view of another exemplary elongate spine.

FIG. 54 is an isometric view of an exemplary spacer.

The figures are not necessarily to scale. Certain features or components herein may be shown in somewhat schematic form and some details of conventional elements may not be shown or described in the interest of clarity and conciseness. The figures are hereby incorporated in and constitute a part of this specification.

### DETAILED DESCRIPTION

The present application describes improvements to the Cartwright references described in the Background. The inventor drew from years of experience in building and operating track vehicles to create the present invention.

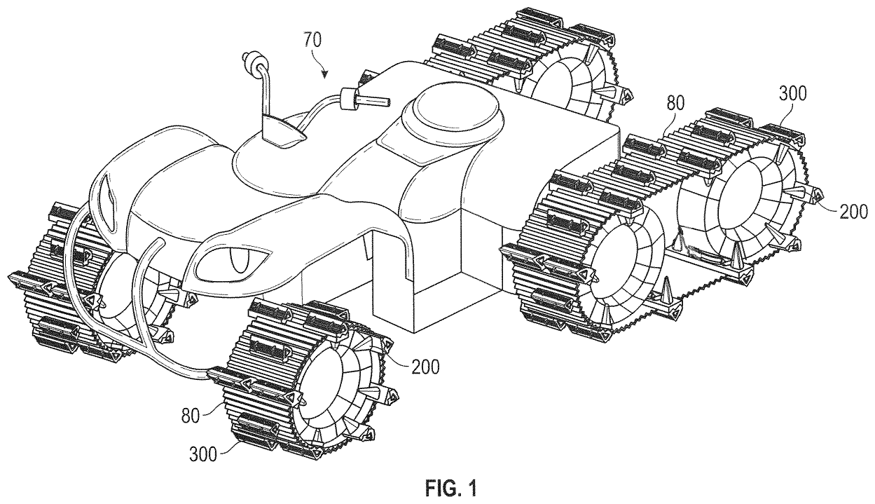

Described herein is a segmented wheel system for a track vehicle 70 (FIG. 1), that may be, for example, an all-terrain vehicle. The segmented wheel system may have a track belt 80 surrounding a segmented wheel 100 on each side of a vehicle (e.g., the front segmented wheels 100 of the vehicle 70 shown in FIG. 1). The segmented wheel system may have a track belt 80 that spans and surrounds multiple segmented wheels 100 on both sides of a vehicle (e.g., the rear segmented wheels 100 of the vehicle shown in FIG. 1). The track belt 80 has an inner surface (also referred to as a drive surface) and an outer surface (also referred to as a running surface). The inner surface is nearer to the segmented wheel(s) 100 than the outer surface. The shown track belt 80 has a relatively flat inner surface and “toothed” outer surface (with elongate teeth 82 spanning the width thereof). The system may include one or more of the following unique components:
(a) at least one segmented wheel 100;
(b) at least one wheel guide 200 positioned on the inner surface of the track belt 80; and
(c) at least one grouser 300 positioned on the outer surface of the track belt 80.
   The segmented wheels 100, wheel guide(s) 200, and grouser(s) 300 may be particularly suited to working in conjunction with the other components.

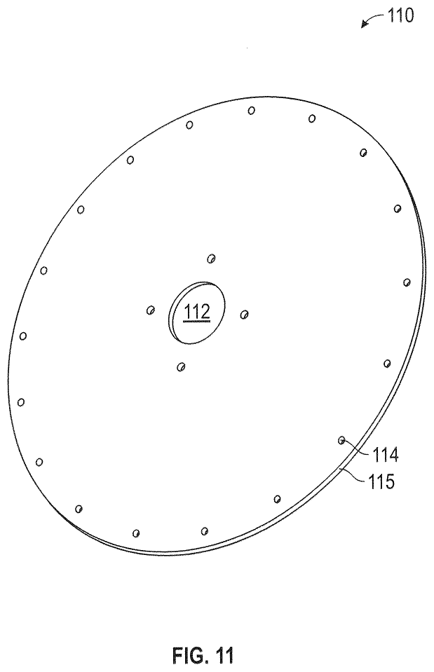

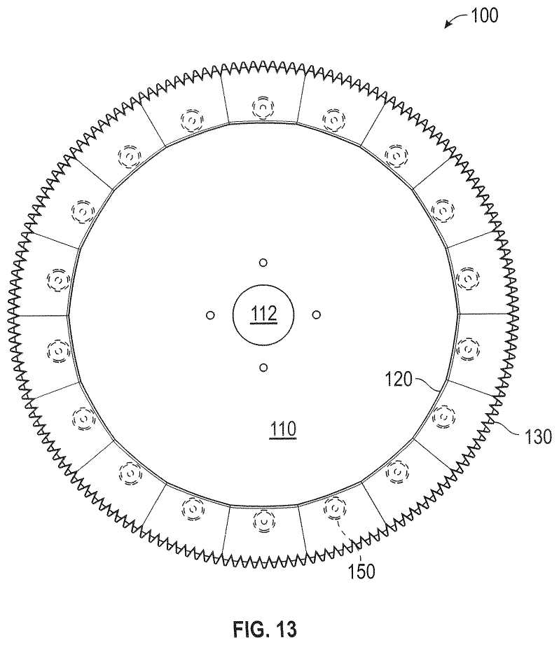

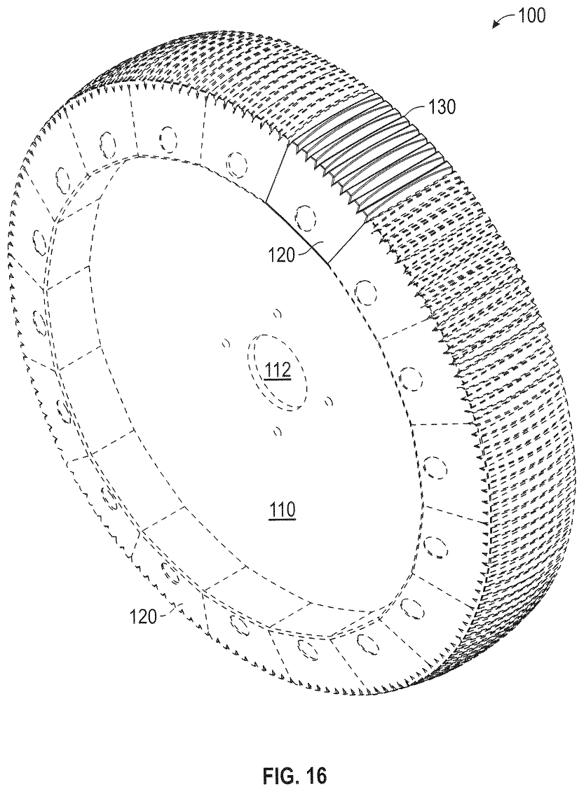

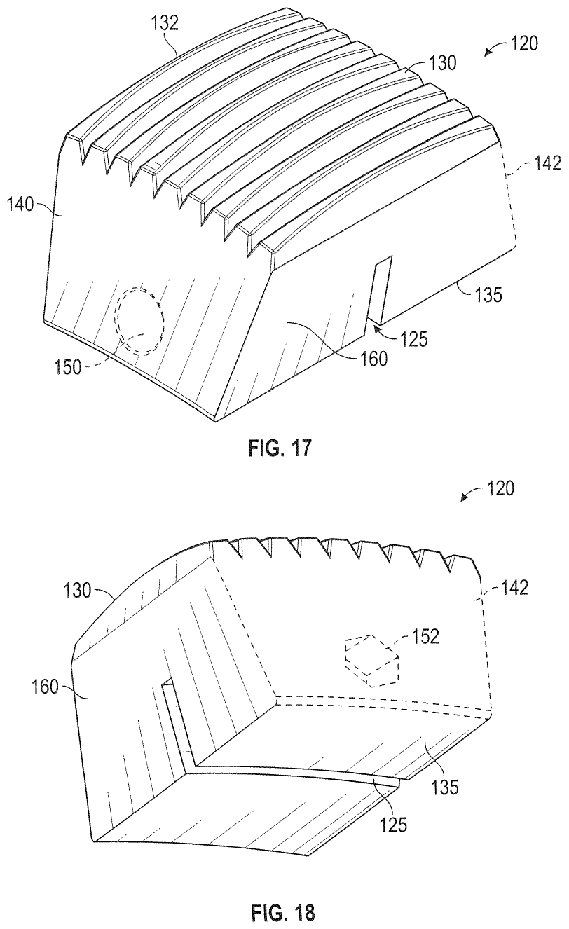

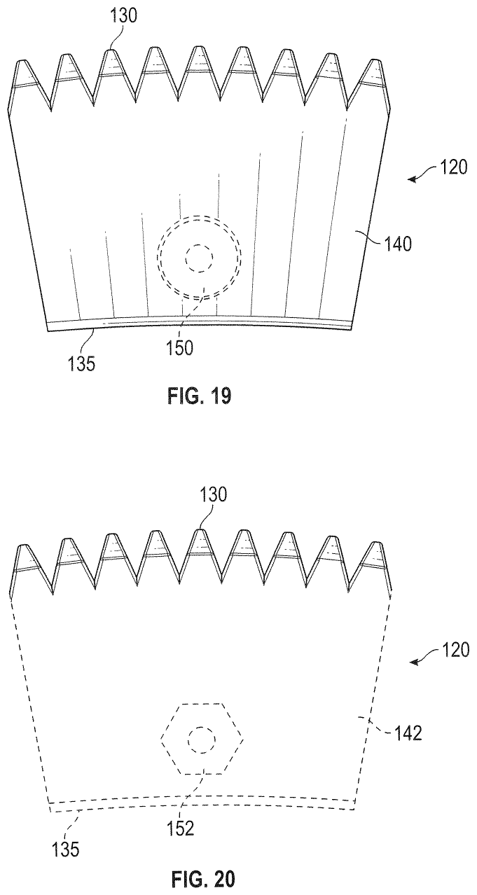

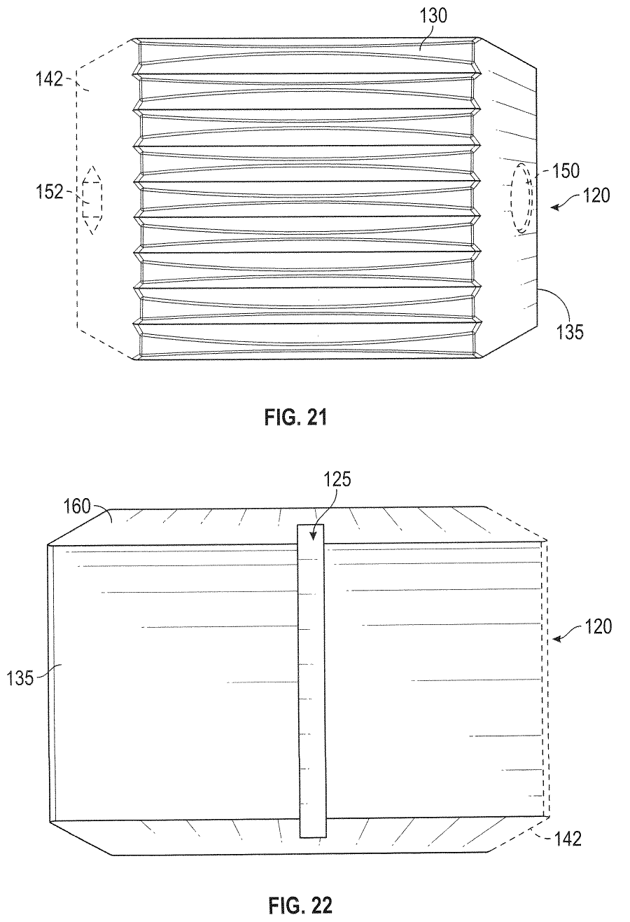

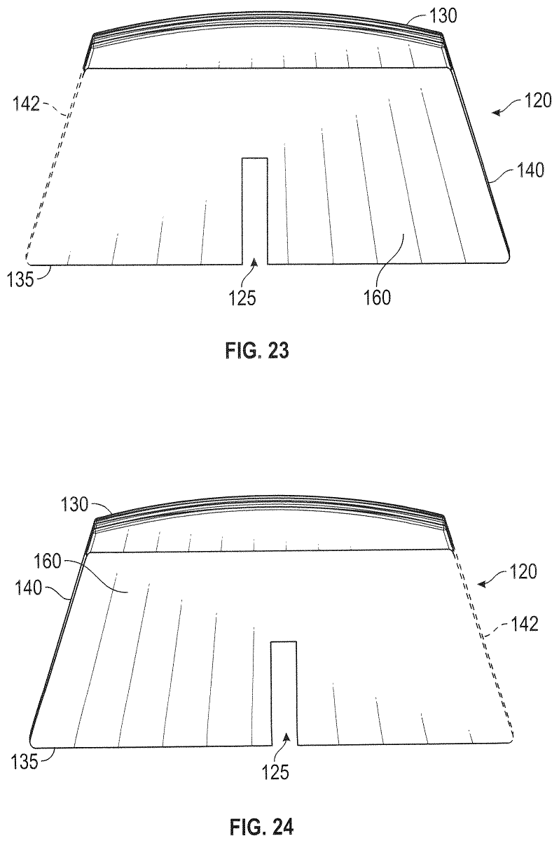

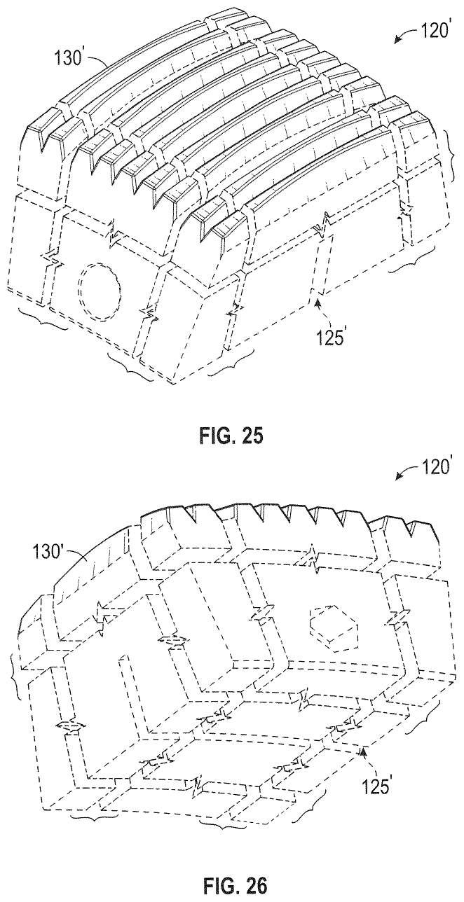

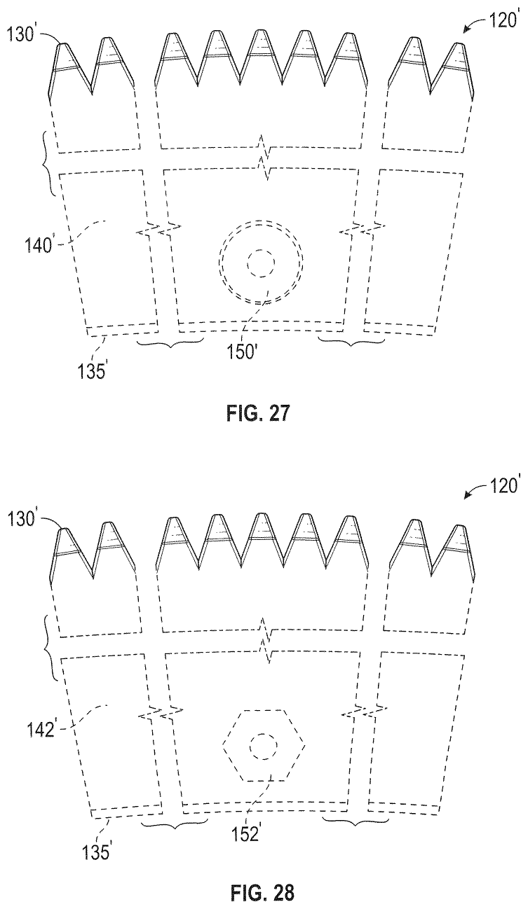

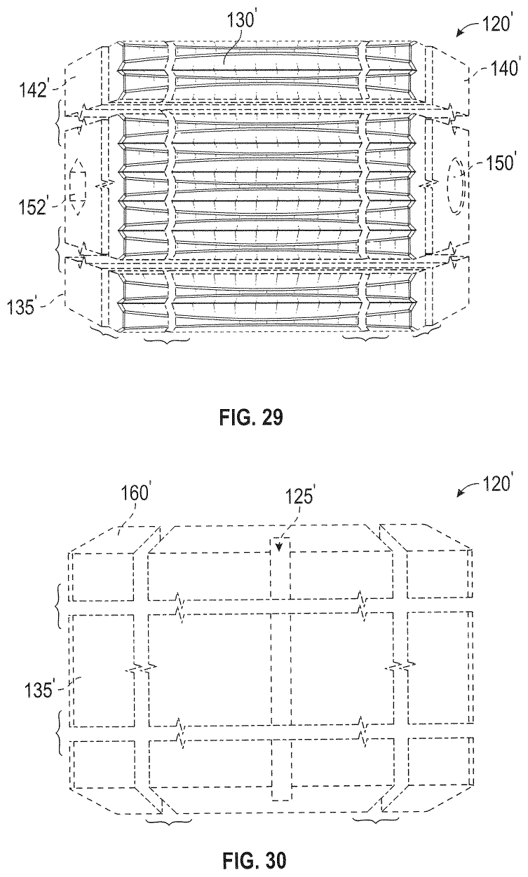

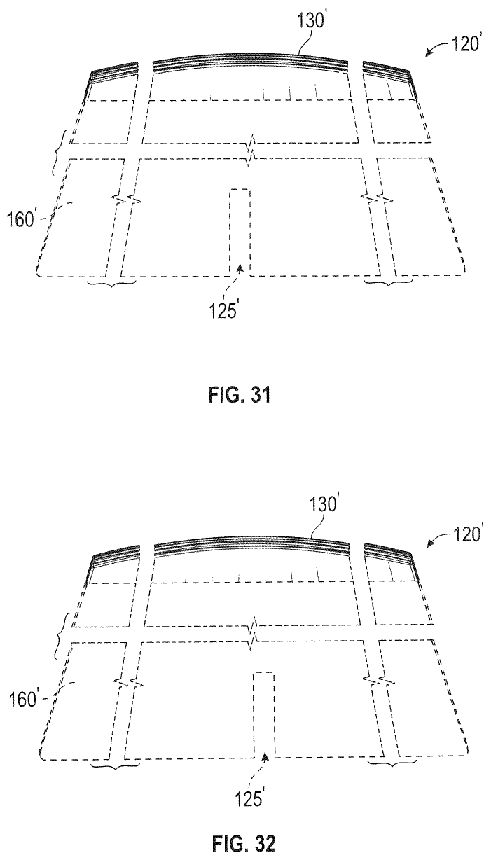

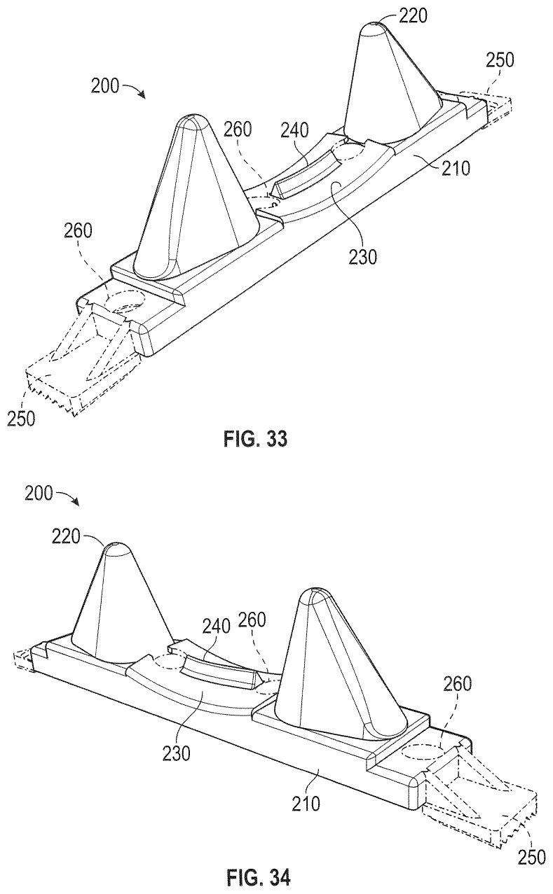

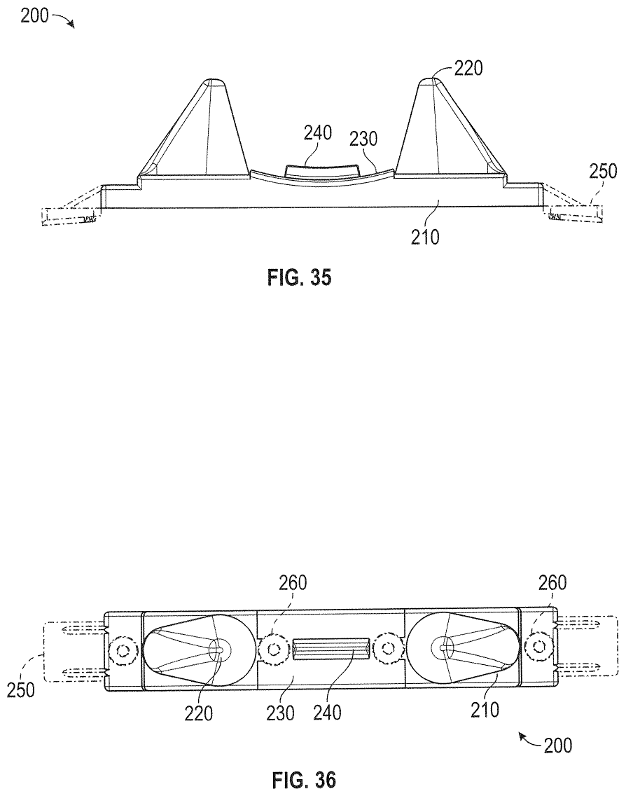

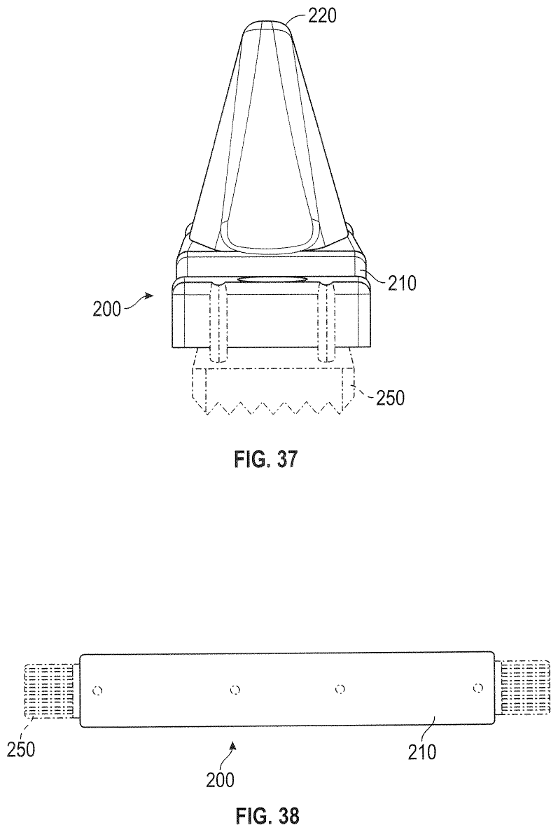

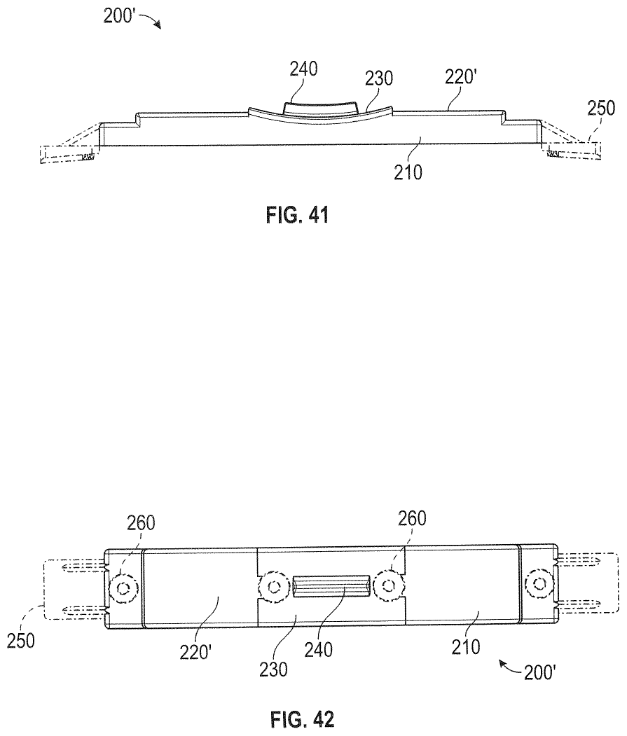

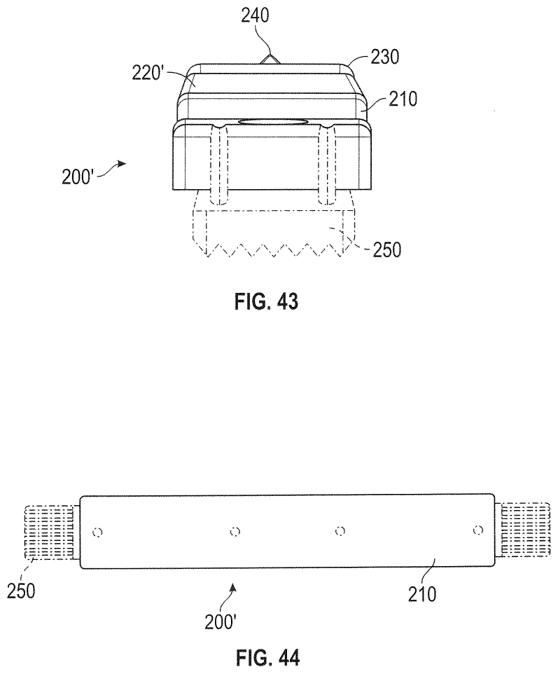

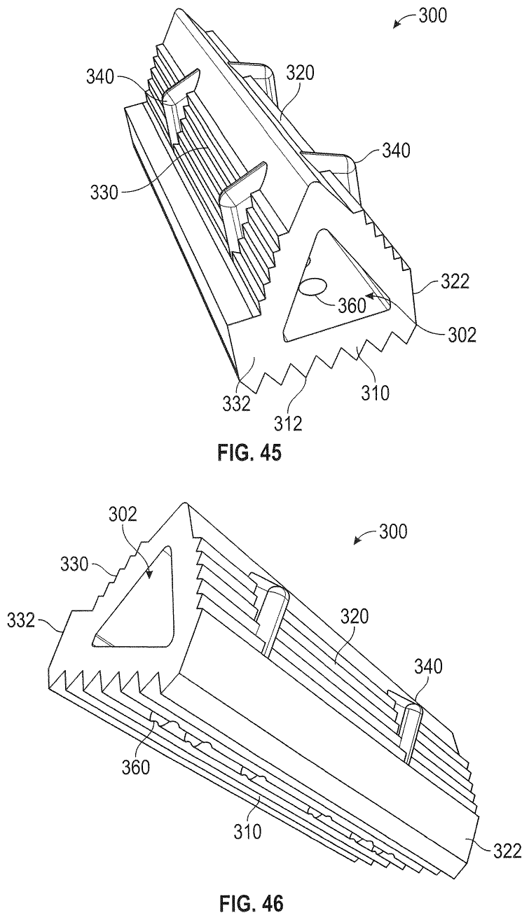

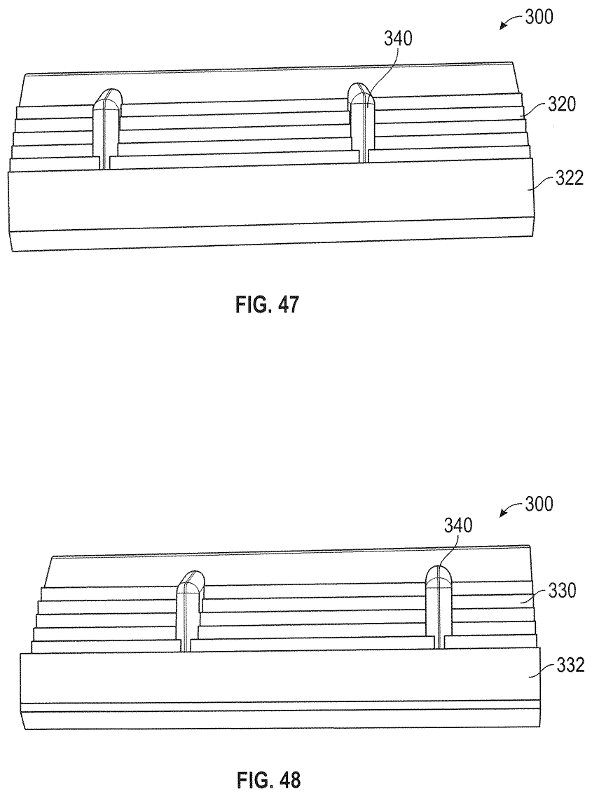

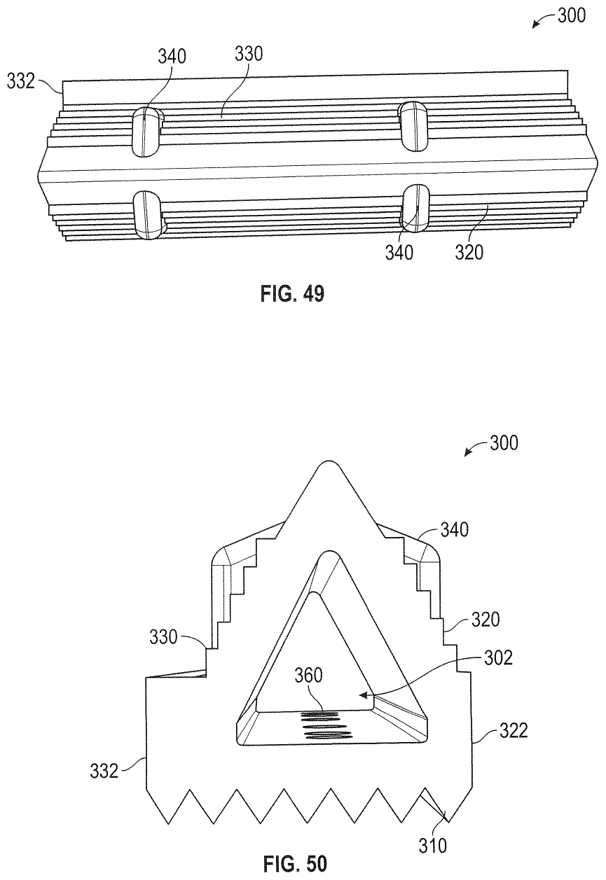

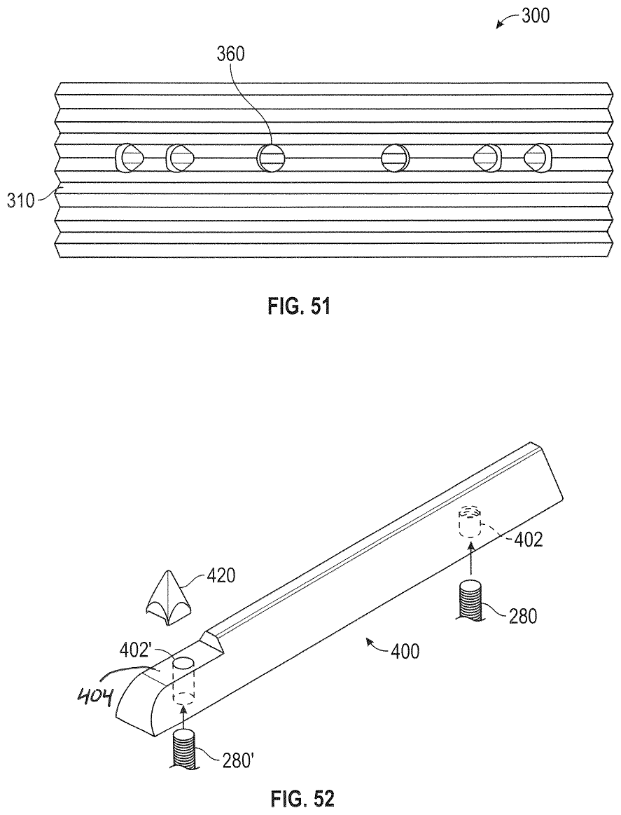

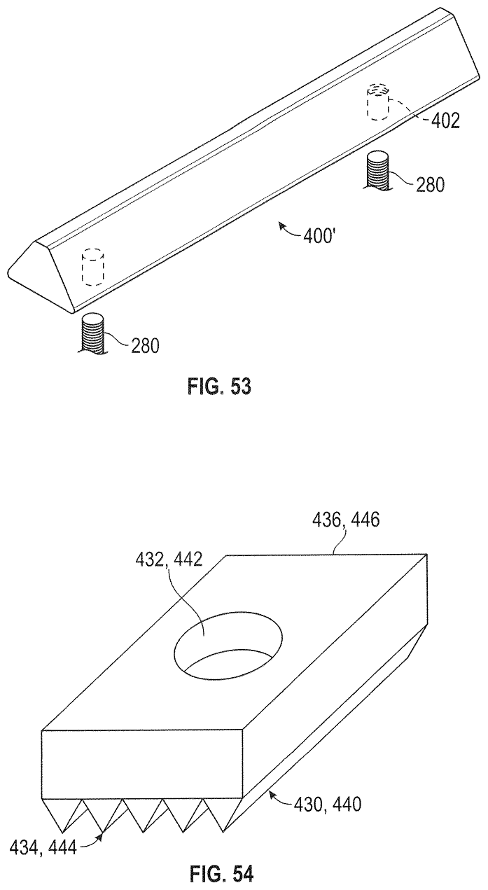

FIGS. 1-10 show the interconnection and interaction between exemplary segmented wheels 100, exemplary wheel guide(s) 200, exemplary grouser(s) 300, and/or other exemplary components of the segmented wheel systems. FIGS. 11-32 show detailed representations of exemplary segmented wheels 100 and/or components thereof (including the exemplary central disk 110 and exemplary wheel segments 120). FIGS. 33-44 show detailed representations of exemplary wheel guides 200, 200′. FIGS. 45-51 show detailed representations of an exemplary grouser 300. FIGS. 52-53 show a detailed representation of exemplary spines 400, 400′. FIG. 54 shows an exemplary spacer 430 or mount 440.

Exemplary segmented wheel systems (and components thereof) may be better understood with reference to the figures, but these segmented wheel systems (and components thereof) are not intended to be of a limiting nature. Unless specified otherwise, the shown shapes and relative dimensions are preferred, but are not meant to be limiting unless specifically claimed, in which case they may limit the scope of that particular claim.

Before describing the segmented wheel systems and the figures, some of the terminology should be clarified. Please note that the terms and phrases may have additional definitions and/or examples throughout the specification. Where otherwise not specifically defined, words, phrases, and acronyms are given their ordinary meaning in the art. The following paragraphs provide basic parameters for interpreting terms and phrases used herein.
The phrase “track vehicle” includes vehicles having a continuous track belt 80 trained over one or more segmented wheels 100 with the track belt 80 in powered movement serving to propel the vehicle over the ground. Exemplary track vehicles include all-terrain vehicles and utility terrain vehicles. FIG. 1 shows exemplary track vehicle 70 that is meant to exemplify all track vehicles.
The term “ground” is meant to include any surface upon which a track vehicle traverses. There are many types of ground terrain including, but not limited to terrain (e.g., paved roads, snow, ice, sand, gravel, mud, rough roads, nonexistent roads, etc.).
The phrases “intended use” or “intended purpose” includes factors including, but not limited to, the terrain to be traversed (ground) and the weight of the vehicle and its contents (hauling weights).
The phrase “manufacturing considerations” includes factors for making the component(s) including, but not limited to, cost of manufacturing (e.g., the cost of materials), the time it will take to manufacture, and the location of manufacturing.
The term “associated” is defined to mean integral or original, retrofitted, attached, connected (including functionally connected), positioned near, and/or accessible by.
It should be noted that some terms used in this specification are meant to be relative. For example, the term “top” is meant to be relative to the term “bottom.” The term “front” is meant to be relative to the term “back,” and the term “side” is meant to describe a “face” or “view” that connects the “front” and the “back.” Rotation of the system or component that would change the designation might change the terminology, but not the concept. For example, “upwardly” extending guide ears 220 would become “downwardly” extending guide ears 220 if the wheel guides 200 are rotated 180 degrees.
It should be noted that some terms (e.g., primary and secondary) are meant to help in the understanding of the technology and are not meant to limit the scope of the invention. Similarly, unless specifically stated otherwise, the terms “first” and “second” are meant solely for purposes of designation and not for order or limitation.
Terms such as “may,” “might,” “can,” and “could” are used to indicate alternatives and optional features and only should be construed as a limitation if specifically included in the claims. It should be noted that the various components, features, steps, or embodiments thereof are all “preferred” whether or not it is specifically indicated. Claims not including a specific limitation should not be construed to include that limitation.
Unless specifically stated otherwise, the term “exemplary” is meant to indicate an example, representation, and/or illustration of a type.
It should be noted that, unless otherwise specified, the term “or” is used in its nonexclusive form (e.g., “A or B” includes, but is not limited to, A, B, A and B, or any combination thereof). It should be noted that, unless otherwise specified, “and/or” is used similarly (e.g., “A and/or B” includes, but is not limited to, A, B, A and B, or any combination thereof). It should be noted that, unless otherwise specified, the terms “includes,” “has,” and “contains” (and variations of these terms) mean “comprises” (e.g., a device that “includes,” “has,” or “contains” A and B, comprises A and B, but optionally may contain C or additional components other than A and B).
It should be noted that, unless otherwise specified, the singular forms “a,” “an,” and “the” refer to one or more than one, unless the context clearly dictates otherwise. Similarly, unless specifically limited, the use of singular language (e.g., “component,” “module,” or “step”) may include plurals (e.g., “components,” “modules,” or “steps”), unless the context clearly dictates otherwise.

### The Segmented Wheel 100 (FIGS. 11-32)

Known “wheels” used in known track vehicles are siped, pneumatic, high-pressure, heavy-duty rubber tires that run within the track belts 80. This was necessary to accommodate potential heavy load usage. The usual vehicle requirement for traction and cushioning (shock absorbing) provided by a pneumatic tire is replaced, as described below, by the grousers 300 mounted on the running surface of the track belt 80.

A segmented wheel 100, as shown and described herein, is a circular unit (tire replacement) that is made up of wheel segments 120 mounted around a central disk 110. Although shown in many of the figures as including eighteen (18) wheel segments 120, the quantity of segmented wheel 100 could be adjusted based on the size of the segmented wheel 100 and/or the size of the wheel segments 120.

A central disk 110 is surrounded by a plurality of wheel segments 120 to form the segmented wheel 100. The outer peripheral edge 115 of the central disk 110 has a thickness. There is a central aperture 112 (which may have a plurality of smaller apertures around it) in the central disk 110 and a plurality of evenly spaced disk connection apertures 114 (one for each wheel segment 120) positioned slightly inward (toward the center) from the peripheral edge 115.

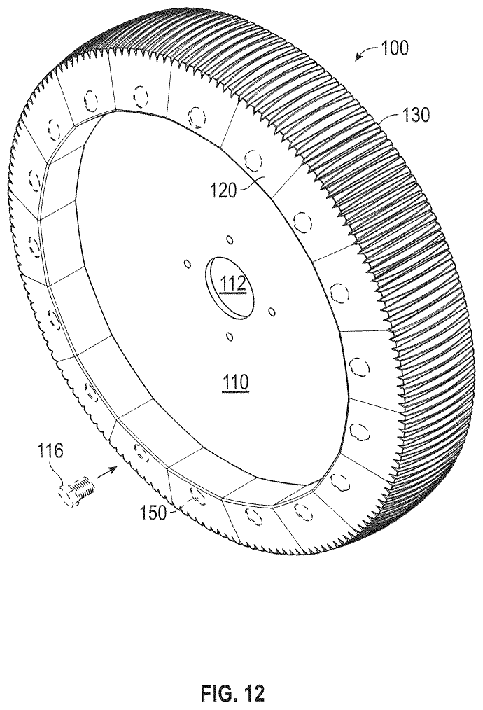

The wheel segments 120 have an outer diameter surface 130 (shown as having elongate teeth 132 thereon), an inner diameter surface 135 (that faces the center of a segmented wheel 100), two faces 140, 142, and two ends 160 (each end 160 of a wheel segment 120 mating with an end 160 of an adjacent wheel segment 120). The outer diameter surfaces 130 of the positioned wheel segments 120 form the outer perimeter of a segmented wheel 100. The inner diameter surface 135 of the positioned wheel segments 120 form the inner perimeter of a segmented wheel 100. Because of the positioning of the wheel segments 120 and the fact that the inner diameter surfaces 135 are shorter (between the faces 160) than the outer diameter surfaces 130 (between the faces 160), when the wheel segments 120 are positioned as shown in FIGS. 12-14 to form a segmented wheel 100, the combined inner diameter surfaces 135 (the inner perimeter of the segmented wheel 100) have a smaller radius than the combined outer diameter surfaces 130 (the outer perimeter of the segmented wheel 100).

The inner diameter surface 135 of each wheel segment 120 has an interconnection slot 125 defined therein (extending from one end 160 of the wheel segment 120 to the opposite end 160 of the wheel segment 120). The interconnection slot 125 interconnects with the disk outer peripheral edge 115. More specifically, when in position, the disk outer peripheral edge 115 is positioned within the interconnection slot 125 of each wheel segment 120.

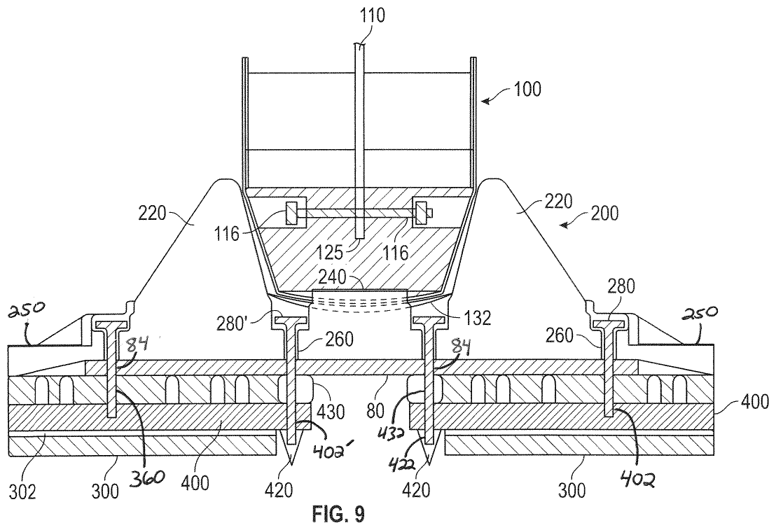

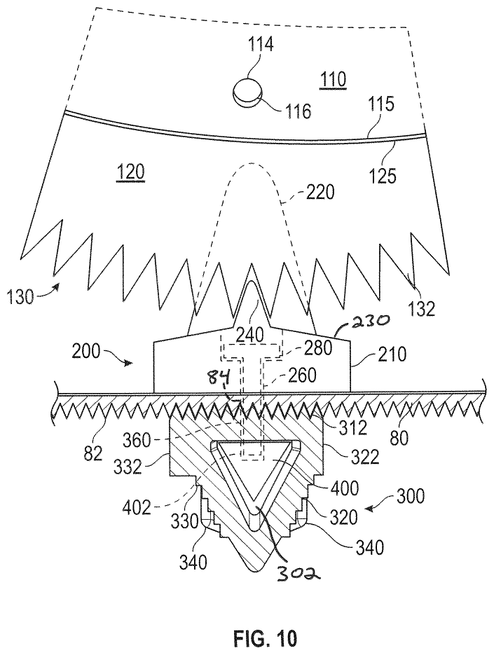

The outer diameter surface 130 is shown as having a texture (e.g., the surface is covered with substantially parallel elongate teeth 132 that are perpendicular to the direction of rotation). The elongate teeth 132 on the outer diameter surface 130 of the wheel segments 120 are meant to engage the central elongate tooth 240 of the wheel guide 200 (FIGS. 9-10). As shown, the elongate teeth 132 may be narrow toward the center of the outer diameter surface 130 and relatively wider toward the outer edges (near the faces 140, 142) of the outer diameter surface 130.

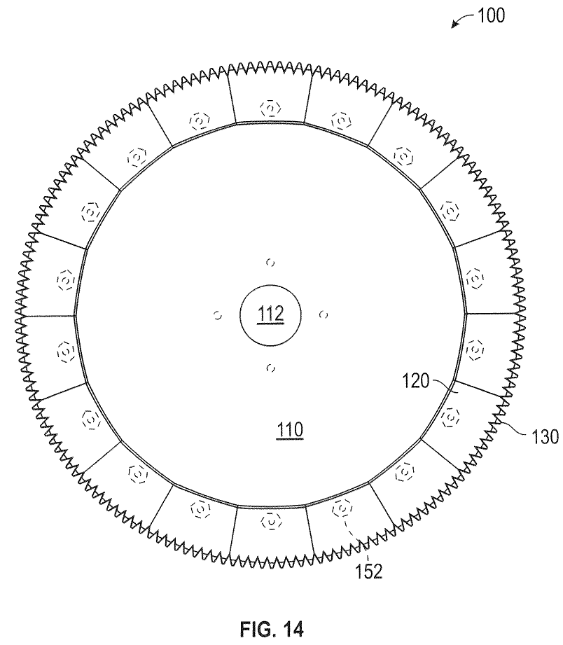

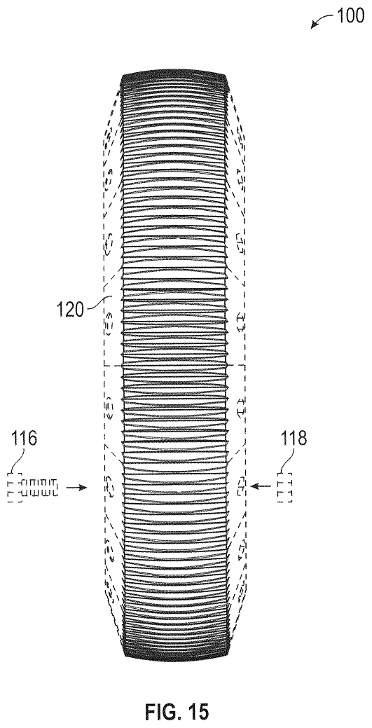

A segment connection aperture 150, 152 (a bore identified by and spanning the distance between the openings 150, 152 on faces 140, 142) extends through each wheel segment 120 from segment face 160 to segment face 160. The segment connection aperture 150, 152 is preferably of a depth such that the segment connection aperture 150, 152 intersects the interconnection slot 125. FIG. 15 shows a connector 116 (shown as a bolt) and a securer 118 (shown as a nut). FIG. 9 shows the connector 116 positioned within the segment connection aperture 150, 152 (not labeled) and through the disk connection apertures (not labeled) and secured by a securer 118 (not labeled) such that the wheel guide 200 is secured to the segmented wheel 100.

The ends 160 of the wheel segments 120 are adjacent (but not attached to) the ends of adjacent wheel segments 120. The individuality of the wheel segments 120 allows for ease of individual wheel segment 120 replacement, if necessary. The wheel segments 120 are easily replaceable in the field by removing the securer 118 from the connector 116, removing the connector 116 from the segment connection aperture 150, 152, removing the old wheel segment 120 from the outer peripheral edge 115 of the central disk 110, positioning a new wheel segment 120 on the outer peripheral edge 115 of the central disk 110, inserting the connector 116 through the segment connection aperture 150, 152 (and the aligned disk connection apertures 114 of the central disk 110 positioned within the interconnection slot 125), and replacing the securer 118 on the shaft of the connector 116. Also, the wheel segments 120 may be manufactured individually using an efficient molding process.

This design at least greatly reduces (and preferably eliminates) the bulk of the friction generated by pneumatic tires against plastic wheel guides. This may be accomplished by the materials used and/or the shapes used. The rubber of traditional tires rubs against tire guides and, thereby, creates friction. As discussed herein, the wheel segments 120 described herein are preferably constructed from (or coated with) reduced or eliminated friction materials. In addition, the wheel segments 120 (e.g., the profile of the faces 140, 142 of the wheel segments 120) may be shaped to minimize contact with the surfaces of the wheel guides 200. For example, the angle of the faces 140, 142 of the segmented wheels 100 are preferably angled similarly to the angle of the surfaces of the guide ears 220 near the radiused valley 230 (see FIG. 9).

Another advantage of the segmented wheel 100 comes from the use of the central disk 110. Traditional tires change in diameter as the air pressure in the tire changes. Diameter changes may result in losing the ability to keep the track belts 80 on and in alignment in a multiple-tire system. Constant checking of the tires' air pressure, therefore, is required. The use of the “no air” central disk 110 eliminates the need to constantly check and keep pressures consistent.

### Wheel Guide 200 (FIGS. 33-44)

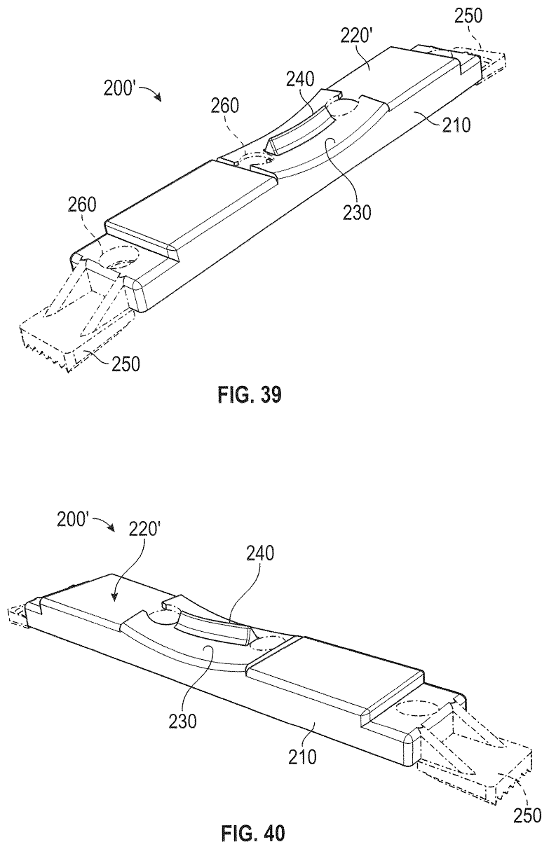

The wheel guide 200 (FIGS. 33-38) is a removable and replaceable component designed to be mechanically fastened to the inner surface (also referred to as a drive surface) of the track belt 80. As shown, the wheel guide 200 described herein has a body 210 with a longitudinal length. Starting from one end of the body 210, the features on the upper surface of a body 210 includes, for example, a first end section 250, a first upwardly extending guide ear 220, a “radiused valley” 230, a second upwardly extending guide ear 220, and a second end section 250. The longitudinal sides of the wheel guides 200 (including the body 210 thereof) can be thought of as “faces” or “longitudinal guide faces” (not labeled). Alternative wheel guides 200′ (FIGS. 39-44), as will be discussed, are similar to the wheel guide 200, but omit the guide ears 220.

The radiused valley 230 of the wheel guides 200 is preferably a radiused central section that is flanked on both ends by “upwardly” extending “guide ears 220.” The specific radius may be similar to the radius of the outer diameter surface 130 (or the elongate tip of its elongate teeth 132) of the segmented wheels 100 (see FIG. 9). The radiused valley 230 is shown as having a central “upwardly” extending elongate tooth 240 that extends parallel to the longitudinal length in the center of the radiused valley 230 (between the guide ears 220). The central elongate tooth 240 is shown as partially spanning the radiused valley 230. As shown, the radiused valley 230 slopes or angles “downwardly” from both faces of the central elongate tooth 240 outward toward the respective longitudinal guide faces of the body 210. This downward sloping or angling allows material (e.g., snow) removed by the central elongate tooth 240 to slide “downward” toward the outer edges (the longitudinal guide faces) of the radiused valley 230.

The elongate tooth 240 is meant to engage elongate teeth 132 on the outer diameter surface 130 of the wheel segments 120. Specifically, the elongate tooth 240 engages the elongate downward groove (that is preferably approximately V-shaped or U-shaped) between adjacent elongate teeth 132. The elongate tooth 240 may have a concave upper elongate “point” that is radiused, sized, and shaped to interact with the downward groove between adjacent elongate teeth 132.

As shown, the guide ears 220 extend “upwardly” from the body 210 and are positioned on either side of the radiused valley 230. The guide ears 220 may be solid, hollow, or include interior support structure (e.g., webbing). The guide ear surfaces near the radiused valley 230 are preferably angled similarly (e.g., at least partially roughly parallel although, as shown, not absolutely parallel) to the angle of the faces 140, 142 of the segmented wheels 100 (see FIG. 9). In use, preferably there is little or no contact between the guide ears 220 and the faces 140, 142, but because of the “slick” materials from which these components are constructed, if there is contact, the friction is minimized. The combined positioning and angling of the guide ears 220 forms a “housing” (or cage) for the segmented wheels 100. This housing keeps the track belt 80 properly positioned on the segmented wheels 100.

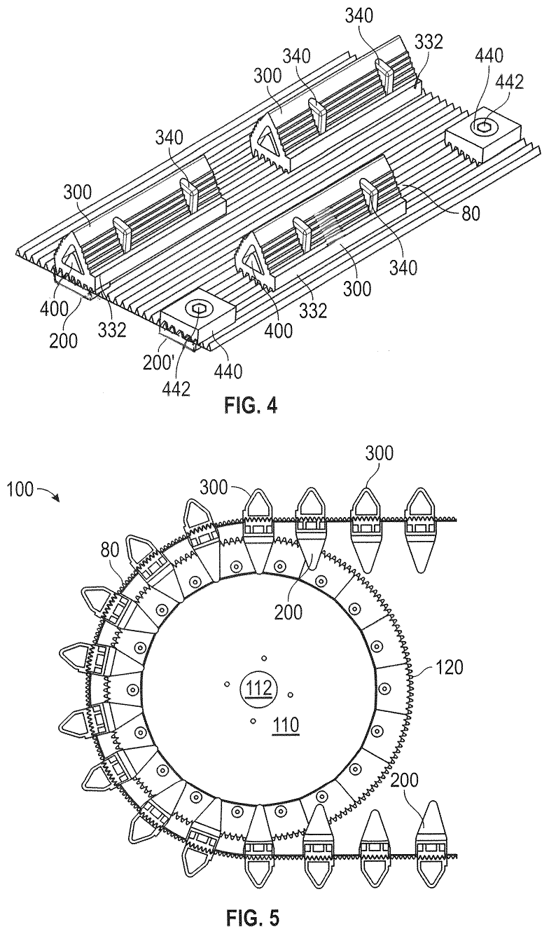

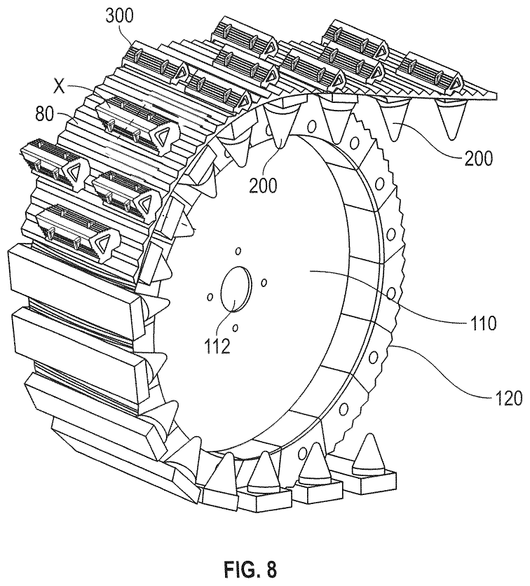

As shown, the wheel guides 200 have first and second end sections 250 toward the opposite ends a body 210. The end sections 250 extend from the side of the guide ears 220 remote from the radiused valley 230 to the respective longitudinal ends of the wheel guides 200. The end sections 250 may include optional extensions (shown in phantom) that may extend beyond the track 80 (see FIG. 9). Inclusion of the extensions allows for a greater gripping surface because the grousers 300 can extend beyond the edges of the track 80. The extensions, however, may be omitted as shown in FIGS. 4 and 8. Omitting the extensions is most likely for narrower front wheels 100.

The wheel guides 200 also include connection apertures 260. As shown, there are connection apertures 260 on both ends of the central elongate tooth 240. The connection apertures 260 may be located within the radiused valley 230 on both sides of the central elongate tooth 240. The connection apertures 260 may also be located within the end sections 250. Another way to describe the shown locations of the connection apertures 260 is that they are positioned through the body 210 on both sides of both guide ears 220.

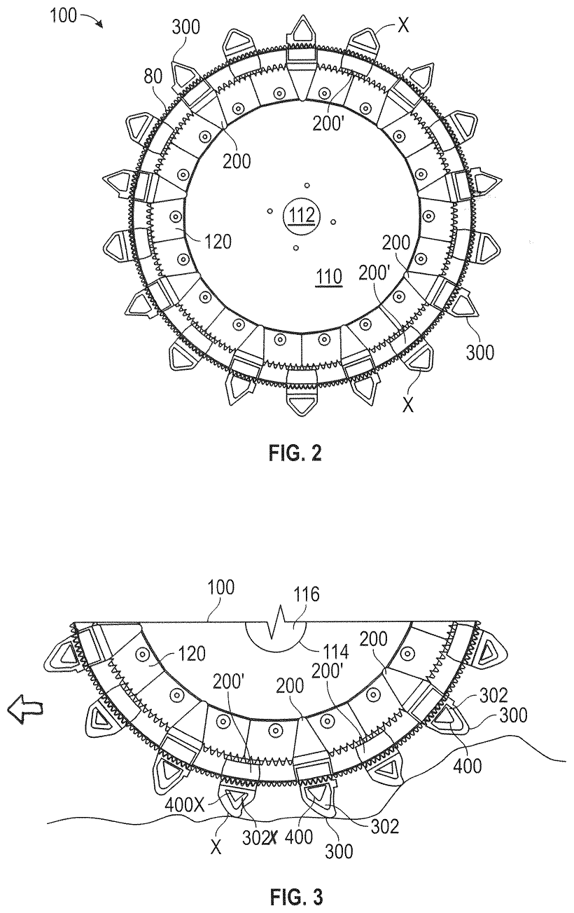

FIGS. 39-44 shown an alternative wheel guide 200′ in which the guide ears 220 are omitted. Instead of the guide ears, the shown alternative wheel guide 200′ has plains 220′. Other than the absence of the guide ears, the structure of the alternative wheel guide 200′ is equivalent to the structure of the wheel guide 200, so the description of the similar components is not being duplicated here. Starting from one end of the body 210, the features of the alternative wheel guide 200′ on the upper surface of a body 210 includes, for example, a first end section 250 (shown with an optional extension in phantom), a first plain 220′, a “radiused valley” 230, a second plain 220′, and a second end section 250 (shown with an optional extension in phantom). The shown connection apertures 260 are positioned on both sides of both plains 220′. As shown in FIGS. 2-3, exemplary front segmented wheels 100 may have an alternating pattern of wheel guides in which every other wheel guide is wheel guide 200 and every other wheel guide is wheel guide 200′.

As will be discussed, the wheel guides 200, 200′ are secured (anchored) to the inner annular surface of the track belt 80 as one of the layers secured by the connectors 280, 280′. When installed, the wheel guides 200, 200′ are secured to the inner annular surface of the track belt 80 opposite at least one grouser 300 (with a spine 400, 400′) on the outer surface of the track belt 80.

### Grouser 300 (FIGS. 45-51)

The grouser 300 is a removable and replaceable component designed to be mechanically fastened to the outer surface (also referred to as a running surface) of the track belt 80. The grousers 300 described herein improve on grousers shown and described in more detail in other Cartwright references including, but not limited to, U.S. Pat. No. 6,540,310 to Cartwright.

The purpose of any grouser on a track belt is to create greater traction. The grouser 300 described herein achieves that. In addition, because the grouser 300 is hollow and made of materials of an appropriate durometer for its intended use, it also provides cushioning (shock absorption). The durometer of the materials may be adjusted to accommodate different vehicles and intended purposes.

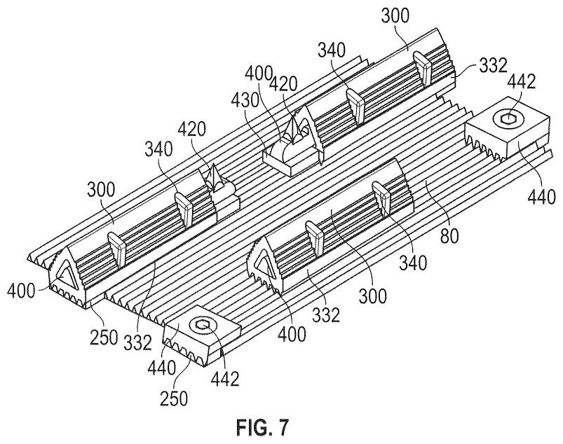

As shown, the hollow grouser 300 has a base 310 and two sides 320, 330 (shown as having a “stair step” pattern on the outer surfaces thereof). The base 310 and two sides 320, 330 together form an approximate prism (having an approximate triangle cross-section). As shown in FIGS. 4 and 7, the bottom “toothed” surface of the base 310 of the grouser 300 has a profile matched to and/or able to interlock with the outer “toothed” outer surface (with elongate teeth 82) of the track belt 80.

The interior surfaces of the base 310 and sides 320, 330 define an approximately prism-shaped interior grouser chamber 302 (having an approximate triangular cross-section). A first grouser side 320 has a face 322. A second grouser side 330 has a heavy reinforcement “foot” or “step” (referred to herein as foot 332). The shown foot 332 spans the length of the grouser side 330 substantially near the base 310. As shown toward the top of the grouser 300, both sides 320, 330 have stability shoulders 340. The base 310 has a plurality of apertures 360. The apertures may be spaced to accommodate the connectors 280, 280′ (shown as bolts). Additional apertures 360 may be included to allow for alternative placements of the grousers 300. Put another way, the same grouser 300 may be used in different positions because of the presence of appropriately defined apertures 360.

The grouser 300 is held to the track belt 80 by a spine 400 positioned within a grouser chamber 302 the grouser 300. The grouser chamber 302 is preferably at least approximately prism shaped (at least approximately triangular in cross-section). Similarly, the spine 400 is preferably at least approximately prism shaped (at least approximately triangular in cross-section). The spine 400, however, has a smaller profile than the grouser chamber 302 such that there is a gap between the interior surface of the hollow grouser 300 (that defines the grouser chamber 302) and the exterior surface of the spine 400. This gap allows for movement and cushioning (shock absorption) on hard surfaces.

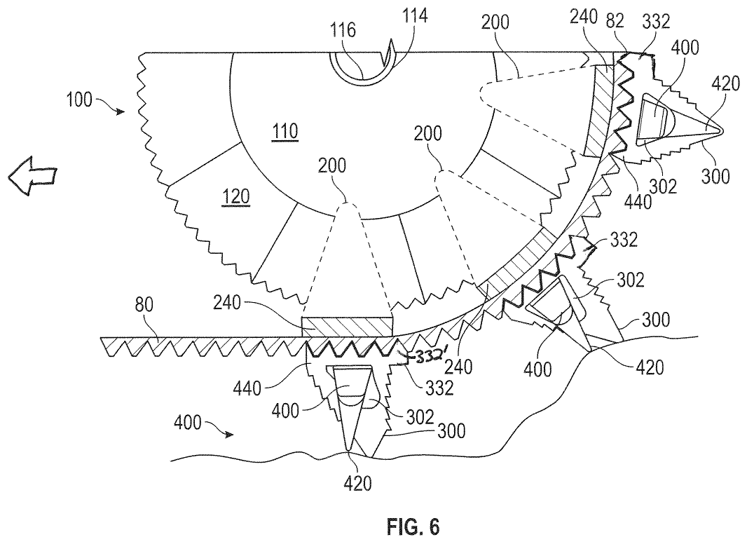

Greater pressures are created in forward vehicle movement than in reverse vehicle movement. In addition, varying speeds, vehicle weight loads, and/or angles (e.g., steepness) of the terrain may cause a transfer of the pressure to the rear of the grouser 300. To accommodate this additional pressure, the grousers 300 preferably include a reinforcement foot 332 of added material. The shown foot 332 may also add at least one additional elongate tooth 332′ (FIG. 6) to the grouser base 310 to provide greater interaction with the elongate teeth 82 of the track 80. As shown in FIGS. 3 and 6, the foot 332 provides a support function that helps the grouser 300 maintain its shape, while still allowing some bending or cushioning. The shown foot 332 has a square-like cross-sectional that provides ease of release from the mold. It should be noted that the foot 332 may have modified or alternative cross-sections.

As shown toward the top of the grouser 300, both sides 320, 330 have stability shoulders 340. The shown stability shoulders 340 are substantially perpendicular to the longitudinal length of the grouser 300. The stability shoulders 340 provide directional stability and anti-skid properties. On the front wheels, the stability shoulders 340 improve steering and turning radius. On the rear wheels, the stability shoulders 340 provide more stability in relation to snow. The shoulders 340 also reinforce the sides 320, 330 to help the grouser 300 retain its prism shape. The position (located higher/lower or more toward the center/edge(s)), size, shape, and quantity of the shoulders 340 could be modified based on based on factors including, but not limited to, intended use and manufacturing considerations. As will be discussed, there is a balance between the grouser 300 retaining its shape so as to hold or grip in the snow and deforming (bending) so as to provide cushioning.

Being molded in urethanes and functioning independently of the track belt 80 gives the grouser 300 an advantage of potential hardness variation needed to accommodate various vehicle weights and loads.

### Additional Structure (FIGS. 52-54)

The grouser 300 is held to the track belt 80 by a spine 400, 400′ inserted into the grouser 300. This is shown, for example, in FIGS. 9 and 10. FIG. 52 shows a spiked spine 400 (with an ice cleat 420) and FIG. 53 shows a non-spiked spine 400′ (without an ice cleat). Except for the alternative cross-section (shown as shorter) portion 404 through which a threaded channel 402′ extends completely, the spines 400, 401′ will be discussed together and referred to generally as spine 400. It should also be noted that prior art spines are discussed in detail in other Cartwright references including, but not limited to, U.S. Pat. No. 6,540,310 to Cartwright as “spline elements.”

The spine 400 is preferably at least approximately prism shaped (at least approximately triangular in cross-section). The bottom surface of the spine 400 has threaded spine apertures 402, 402′. The threaded spine apertures 402 are shown as partial bores that extend partially through the spine 400. The threaded spine apertures 402′ are shown as channels that extend completely through the spine 400. The presence of the threaded spine apertures 402′ is a distinction between the spiked spine 400 described herein and the known spline elements. Significantly, the ice cleat 420 has a threaded spike aperture 422. The threaded spike aperture 422 functions similarly to a “nut” as it is used to secure the respective connector 280′. Known ice cleats have threaded posts that thread downwardly into threaded apertures on the upper surface of the spline elements. Long connectors 280′ may be used to attach an ice cleat 420 (spike) by extending through layers including a wheel guide 200, track 80, spacer 420, grouser 300, spine 400, and ice cleat 420. The threaded spike aperture 422 functions similarly to a “nut” as it is used to secure the respective connector 280′.

The spine 400 has a smaller profile than the grouser chamber 302 such that there is a gap between the interior surface of the hollow grouser 300 (that defines the grouser chamber 302) and the exterior surface of the spine 400. The gap allows for movement and cushioning (shock absorption) on hard surfaces. The sides of the spine 400 may be straight, bowed, arced, ribbed, or stepped, but the basic shape is triangular (scalene, isosceles, or equilateral). As with the grouser 300, the cross-sectional shape of the spine 400 may be determined by the intended use and manufacturing considerations.

FIG. 54 shows an exemplary spacer 430 or mount 440. FIG. 9 shows an exemplary spacer 430 in use. FIGS. 4 and 7 show an exemplary mount 440 in use. The spacer/mount 430, 440 basically have similar structure including a body 436, 446 with an upper body surface and a bottom body surface. As shown, the bottom surface may have teeth 434, 444 to mate with the toothed surface of a track 80. An aperture 432, 442 extends through the body 436, 446 from the upper body surface to the bottom body surface (including through the teeth 434, 444). The shape and size of the cross-sectional shape of the spacer(s)/mount(s) 430, 440 may be determined by the intended use and manufacturing considerations.

### Assembly, Use, and Variations

To attach a wheel segment 120 to the central disk 110 (e.g., to form the segmented wheel 100 or to replace a damaged or missing wheel segment 120), the outer peripheral edge 115 of the central disk 110 is inserted into the interconnection slot 125 of the wheel segment 120. (This can also be described as the interconnection slot 125 of the wheel segment 120 being positioned over the outer peripheral edge 115 of the central disk 110.) The wheel segment 120 is then positioned such that the segment connection aperture 150, 152 aligns with a disk connection aperture 114. (A channel is formed by the aligned segment connection aperture 150, 152 and the disk connection aperture 114.) A connector 116 (e.g., a bolt) may then be threaded through the segment connection aperture 150, 152 and disk connection aperture 114 and secured using a securer 118 (e.g., using a nut). FIG. 9 shows the resulting configuration. This procedure is repeated for each wheel segment 120. When all the wheel segments 120 are positioned around the central disk 110, the outer diameter surfaces 130 of the wheel segments 120 form an annular outer diameter surface of the segmented wheel 100.

As shown, the wheel guides 300 are attached to the relatively flat inner surface (drive surface) of the track belt 80 and the grousers 300 are attached to the toothed outer surface (running surface having elongate teeth 82) of the track belt 80. Preferably, each wheel guide 300 is aligned with, albeit on the opposite side of the track, as a row having at least one grouser 300. This is shown, for example, in FIG. 10. The extreme stiffness of the high-durometer wheel guides 200 commands flatness in the otherwise flexible track belt 80.

Single segmented wheels 100 (e.g., one wheel on both sides of the vehicle 70) such as the shown front segmented wheels 100 (the front wheels of a vehicle 70) may have a track 80 with an alternating wheel guide pattern in which the wheel guides alternate between the wheel guide 200 (FIGS. 33-38) and the wheel guide 200′ (FIGS. 39-44) as shown in FIGS. 2-3. Using some of the alternative wheel guide 200′ without the guide ears reduces the weight of the system and reduces expenses (because less material is used). Although the wheel guides may have an alternating pattern, alternatively, all the wheel guides are wheel guides 200 with the guide ears 220. Depending on the spacing of the wheel guides, all the wheel guides on the track 80 spanning the rear segmented wheels 100 (the rear wheels of a vehicle 70) are wheel guides 200 (with guide ears 220). Theoretically, however, if the wheel guides on the track 80 spanning the rear segmented wheels 100 are close enough together, there could be an alternating pattern. Similarly, vehicles that have single rear wheels 100 (one wheel on both sides of the vehicle similar to the shown front wheels) could use an alternating wheel guide pattern.

The shown grouser alternating pattern (FIGS. 1, 4, and 7) that alternates a row of two spaced and edge-aligned grousers 300 with a row of a single central grouser 300 is meant to be exemplary. One alternative grouser pattern has all the rows include a single long grouser that spans the distance between the edges of the track. Another alternative grouser pattern has all the rows include two spaced and edge-aligned grousers. It is possible to have more than two grousers in a row. As shown in FIGS. 4 and 7, rows with a single central grouser may have a mount 440 at or near (including extending beyond) both the track edges. In addition, as shown in FIGS. 2-3, some of the grousers may be alternative grousers X that have features (e.g., chambers 302X and spines 400X) that have alternative shapes and/or sizes from the grousers 300. The grousers X could be the grousers shown and described in more detail in other Cartwright references including, but not limited to, U.S. Pat. No. 6,540,310 to Cartwright. The grousers X could also be grousers 300 (such that the pattern does not alternate). The grousers X could also be grousers similar to the grousers 300 but having different sizes (e.g., longer, taller, shorter (length or height), wider, and/or narrower) or different features (e.g., with or without at least one foot 322, with or without at least one stabilizing shoulder 340, with or without at least one ice cleat 420).

As shown in FIGS. 9 and 10, connectors 280, 280′ (shown as bolts) may be used to connect and secure a plurality of layers. Using a shorter connector 280, the plurality of layers may include a wheel guide 200 (with wheel guide connection apertures 260), track 80 (with track apertures 84), grouser 300 (with grouser apertures 360), and spine 400 (with threaded spine apertures 402). The threaded spine aperture 402 functions similarly to a “nut” as it is used to secure the respective connector 280. In situations where longer connectors 280′ are used to attach an ice cleat 420 (spike), the layers include a wheel guide 200 (with wheel guide connection apertures 260), track 80 (with track apertures 84), spacer 420 (with spacer aperture 432), grouser 300 (with grouser apertures 360), spine 400 (with threaded or unthreaded spine apertures 402′), and spike 420 (with a threaded spike aperture 422). The threaded spike aperture 422 functions similarly to a “nut” as it is used to secure the respective connector 280′.

As mentioned, the two guide ears 220 on each wheel guide 200 form a “housing” for the segmented wheels 100 so that the track belt 80 does not slip off the segmented wheels 100. As the track belt 80 rotates (the drive wheel 100 causing the track belt 80 to rotate), the central elongate tooth in the radiused valley 230 of the wheel guides 200 interlocks with the matching toothed outer diameter surface 130 of the segmented wheels 100. This coordinating combination of wheel guides 200 to segmented wheel 100 creates a sprocket-type drive for vehicle propulsion.

The structure and materials work together to provide a balance between the grouser 300 retaining its shape (so as to hold or grip on various terrain) and deforming (bending) so as to provide cushioning (shock absorption). Structure that helps the grouser 300 retain its shape include, but is not limited to the foot 332, shoulders 340, and the spine 400. In addition to the type of material used, the presence of the gap in the grouser chamber 302 (between the inner surface of the grouser 300 and the outer surface of the spine 400) help provide cushioning.

### Materials

The specific materials used for the components described herein are meant to be exemplary. Considerations for the choice of materials would be based on factors including, but not limited to, intended use and manufacturing considerations. The following are examples of the types of materials that may be used in constructing the various components:
(a) A central disk of the segmented wheel may be made from sturdy weight materials such as metal (although a thick plastic such as polycarbonates could function as well). Preferred central disks are made of aluminum (e.g., 6061-T6).
(b) A wheel segment of the segmented wheel may be made from hard, but not brittle, materials such as plastics or alloys. The material should be strong and durable. Exterior surfaces of the wheel segment that come into contact with other components are preferably either slick or coated with a slick material to at least reduce friction. The construction material and/or coating may be reduced or eliminated friction materials (e.g., ultra-high-molecular-weight (UHMW) polyethylene, low friction alloys, non-friction alloys, TEXIN(R), DELRIN(R), and other “slick” materials). The wheel segments may be injection molded or cast. At least the teeth of the wheel segments are at least slightly softer (having a lower durometer) than the wheel guides.
(c) A wheel guide may be made from sturdy weight materials such as metal plastics. The material should be strong and durable. Exterior surfaces of the wheel guide that come into contact with other components are preferably either slick or coated with a slick material to at least reduce friction. The construction material and/or coating may be reduced or eliminated friction materials (e.g., ultra-high-molecular-weight (UHMW) polyethylene, low friction alloys, non-friction alloys, TEXIN(R), DELRIN(R), and other “slick” materials). The wheel guides may be injection molded or cast. Preferably, the wheel guide has an 85-100 durometer, and preferred wheel guides have a 92-96 durometer.
(d) A grouser may be made from sturdy and flexible materials such as rubber or urethane. The material should be hard enough to withstand wear, support heavy weights, and provide traction for hard or slick surfaces. The material should also be flexible to provide a cushioning (shock absorbing) effect. Preferably, the grouser has a 60-90 durometer. The harder durometers increase support for heavier weights and allow better traction for hard and slick surfaces. Softer durometers provide greater cushioning (shock absorption)) on hard surfaces. Preferred materials may be a custom-developed urethane that provide significantly improved and/or increased durability.
(e) A spine may be made from sturdy weight materials such as metal (e.g., aluminum), plastic, TEXIN(R), or DELRIN(R). Preferably, the wheel guide has an 85-100 durometer, and preferred wheel guides have a 92-96 durometer. The spines may be made from the same material as the wheel guides.

### Miscellaneous

It is to be understood that the inventions, examples, and embodiments described herein are not limited to particularly exemplified materials, methods, and/or structures. It is to be understood that the inventions, examples, and embodiments described herein are to be considered preferred inventions, examples, and embodiments whether specifically identified as such or not. The shown inventions, examples, and embodiments are preferred, but are not meant to be limiting unless specifically claimed, in which case they may limit the scope of that particular claim.

It is to be understood that for methods or procedures disclosed herein that include one or more steps, actions, and/or functions for achieving the described actions and results, the methods' steps, actions, and/or functions may be interchanged with one another without departing from the scope of the present invention. In other words, unless a specific order of steps, actions, and/or functions is required for proper or operative operation of the methods or procedures, the order and/or use of specific steps, actions, and/or functions may be modified without departing from the scope of the present invention.

All references (including, but not limited to, foreign and/or domestic publications, patents, and patent applications) cited herein, whether supra or infra, are hereby incorporated by reference in their entirety.

The terms and expressions that have been employed in the foregoing specification are used as terms of description and not of limitation, and are not intended to exclude equivalents of the features shown and described. While the above is a complete description of selected embodiments of the present invention, it is possible to practice the invention using various alternatives, modifications, adaptations, variations, and/or combinations and their equivalents. It will be appreciated by those of ordinary skill in the art that any arrangement that is calculated to achieve the same purpose may be substituted for the specific embodiment shown. It is also to be understood that the following claims are intended to cover all of the generic and specific features of the invention herein described and all statements of the scope of the invention that, as a matter of language, might be said to fall therebetween.

What is claimed is:

1. A segmented wheel system for a track vehicle, said system comprising:
(a) said track vehicle having a plurality of segmented wheels;
(b) a track belt surrounding at least one segmented wheel, said track belt having an inner surface and an outer surface, said inner surface nearer to said at least one segmented wheel than said outer surface;
(c) at least one wheel guide positioned on said inner surface of said track belt; and
(d) at least one grouser positioned on said outer surface of said track belt.

2. The system of claim 1, each of said plurality of segmented wheels having a central disk and a plurality of wheel segments.

3. The system of claim 1, said at least one segmented wheel being a plurality of segmented wheels, said track belt surrounding said plurality of segmented wheels, said inner surface nearer to said plurality of segmented wheels than said outer surface.

4. The system of claim 1, each of said plurality of segmented wheels comprising:
(a) a central disk having an outer peripheral edge, a central aperture, and a plurality of evenly spaced disk connection apertures positioned slightly inward from said peripheral edge;
(b) a plurality of wheel segments, each wheel segment having an inner diameter surface, an outer diameter surface, two faces, and two ends;
(c) said inner diameter surface having an interconnection slot defined therein; and
(d) for each wheel segment, said outer peripheral edge of said central disk is positioned within said interconnection slot of said wheel segment, said wheel segment is positioned such that said segment connection aperture aligns with one of said disk connection apertures, and a bolt is positioned within a channel formed by said segment connection aperture and said disk connection aperture.

5. The system of claim 1, each wheel guide having a longitudinal length that includes a first end section, a first upwardly extending guide ear, a radiused valley, a second upwardly extending guide ear, and a second end section.

6. The system of claim 1, each wheel guide comprising:
(a) a longitudinal length that includes a first end section, a first upwardly extending guide ear, a radiused valley, a second upwardly extending guide ear, and a second end section;
(b) said radiused valley having a radiused central section flanked on both ends by said guide ears;
(c) said radiused valley having a central elongate tooth parallel to said longitudinal length; and
(d) said radiused valley on either side of the central elongate tooth angled downward from said central elongate tooth.

7. A segmented wheel, comprising:
(a) a central disk having an outer peripheral edge, a central aperture, and a plurality of evenly spaced disk connection apertures positioned slightly inward from said peripheral edge;
(b) a plurality of wheel segments, each wheel segment having an inner diameter surface, an outer diameter surface, two faces, and two ends;
(c) said inner diameter surface having an interconnection slot defined therein; and
(d) for each wheel segment, said outer peripheral edge of said central disk is positioned within said interconnection slot of said wheel segment, said wheel segment is positioned such that said segment connection aperture aligns with one of said disk connection apertures, and a bolt is positioned within a channel formed by said segment connection aperture and said disk connection aperture.

8. A segmented wheel system for a track vehicle having at least one track belt, each said track belt having an inner belt surface and an outer belt surface, said system comprising:
(a) a plurality of segmented wheels;
(b) at least one segmented wheel surrounded by said track belt, said inner belt surface nearer to said at least one segmented wheel than said outer belt surface;
(c) at least one wheel guide positioned on said inner belt surface of said track belt; and
(d) at least one grouser positioned on said outer belt surface of said track belt.

9. The system of claim 8, each of said plurality of segmented wheels having a central disk and a plurality of wheel segments.

10. The system of claim 8, said at least one segmented wheel being a plurality of segmented wheels, said track belt surrounding said plurality of segmented wheels, said inner belt surface nearer to said plurality of segmented wheels than said outer belt surface.

11. The system of claim 8, each of said plurality of segmented wheels comprising:
(a) a central disk having an outer peripheral edge, a central aperture, and a plurality of evenly spaced disk connection apertures positioned slightly inward from said peripheral edge;
(b) a plurality of wheel segments, each wheel segment having an inner diameter surface, an outer diameter surface, two faces, and two ends;
(c) said inner diameter surface having an interconnection slot defined therein; and
(d) for each wheel segment, said outer peripheral edge of said central disk is positioned within said interconnection slot of said wheel segment, said wheel segment is positioned such that said segment connection aperture aligns with one of said disk connection apertures, and a bolt is positioned within a channel formed by said segment connection aperture and said disk connection aperture.

12. The system of claim 8, each wheel guide having a longitudinal length that includes a first end section, a first upwardly extending guide ear, a radiused valley, a second upwardly extending guide ear, and a second end section.

13. The system of claim 8, each wheel guide comprising:
(a) a longitudinal length that includes a first end section, a first upwardly extending guide ear, a radiused valley, a second upwardly extending guide ear, and a second end section;
(b) said radiused valley having a radiused central section flanked on both ends by said guide ears;
(c) said radiused valley having a central elongate tooth parallel to said longitudinal length; and
(d) said radiused valley on either side of the central elongate tooth angled downward from said central elongate tooth.
